(19) United States
(12) Patent Application Publication
(10) Pub. No.: US 2025/0379392 A1
(43) Pub. Date: Dec. 11, 2025

(54) Vehicle Slide Mount For Multiple Components

(71) Applicant: John J. Lazar, Bellport, NY (US)

(72) Inventor: John J. Lazar, Bellport, NY (US)

(21) Appl. No.: 18/916,241

(22) Filed: Oct. 15, 2024

Related U.S. Application Data
(60) Provisional application No. 63/648,206, filed on Jun. 6, 2024.
(60) Provisional application No. 63/658,643, filed on Jun. 11, 2024.

(51) Int. Cl. H01R 13/518

(52) U.S. Cl. CPC H01R 13/518; H01R 2201/24; H01R 2201/26

(57) ABSTRACT

The embodiment of the invention provides a combination bracket and electrical connector assembly for plural components for removable installation into a vehicle. The combination includes a bracket assembly that surrounds two or more stacked components, holding the components together. An upper connector assembly has a first housing and a bottom open face and has plural first connecting elements mounted into the first housing, the upper connecting assembly arranged for mounting onto a vehicle surface. A lower connector assembly has a second housing and a top open face and is arranged for mounting onto the bracket assembly, the lower connector assembly having plural second connecting elements mounted into the second housing. The plural first connecting elements arranged to automatically engage the plural second connecting elements when the lower connector assembly is slid under the upper connector assembly.

This application claims the benefit of U.S. Provisional Application Ser. No. 63/658,643, filed Jun. 11, 2024 and U.S. Provisional Application Ser. No. 63/648,206, filed Jun. 6, 2024.

### BACKGROUND

Conventional and current technology limit installation of radios under dashboard or other locations using slide mounts to a single antenna radio. Current technology does not allow expansion of more advanced radios that need more than one antenna on a vehicle for multi-band use. Current technology does not provide for stacked components such as a radio and an amplifier in a stacked configuration. Current technology does not provide for multiple antennas using independent coaxial paths and instead use an expander such as a duplexer or triplexer that allow multi-share of the same communication coaxial path. Using an expander limits the best optimal transmissions and performance and Standing Wave Ratio (SWR) for different devices.

The present inventor has recognized that the best and optimal reception and transmission of a radio wave is to provide each band its own separate antenna coaxial path and antenna coaxial cable straight from the radio without compromising in sharing of the line with another band.

The present technology of single coaxial antenna slide mount is limited to this one radio and one antenna technology.

### SUMMARY

The exemplary embodiment of the present invention provides a mounting arrangement for stacked components such as multi-antenna-based radios, amplifiers, stereos, and GPS scanners. The arrangement provides for single-handed removal of the device in an easy-to-use automatic install of the stacked components. The arrangement can be used for under the dashboard or other locations having a single slide mount. The arrangement installs and disconnects all radios and scanners, power wires, antennas, public address (PA), GPS antenna, and accessories in one pull. This has applications for all types of situations as a base station or in vehicles or boats and for all radio frequencies such as police and fire scanners and not limited to Amateur Radio Band (Ham), Citizens Band (CB), Family Radio Service (FRS), General Mobile Radio Service (GMRS), simple stereo receivers and amplifiers, or navigation systems.

The embodiment of the invention provides a combination bracket and electrical connector assembly for plural components for removable installation into a vehicle. The combination includes a bracket assembly that surrounds two or more stacked components, holding the components together. An upper connector assembly has a first housing and a bottom open face and has plural first connecting elements mounted into the first housing, the upper connecting assembly arranged for mounting onto a vehicle surface. A lower connector assembly has a second housing and a top open face and is arranged for mounting onto the bracket assembly, the lower connector assembly having plural second connecting elements mounted into the second housing. The plural first connecting elements arranged to automatically engage the plural second connecting elements when the lower connector assembly is slid under the upper connector assembly.

The embodiment can have two of the plural first connecting elements and two of the plural second connecting elements dedicated to connecting two antennas each dedicated to a different signal band.

The exemplary embodiment of the present invention provides a slide mount for two or more components so that more than one coaxial line can be received from the radio in a non-shared separate radio communication line for each separate band. This would allow a separate antenna for each separate band for the radios. This would greatly improve communication reception and improve convenience at the same time.

Additionally, the stacked convenience of having an additional component in the bracket would allow the convenience of the one-hand slide mount but room for having an amplifier to boost the signal right there in the same bracket. This way the entire radio and amplifier can be removed as one unit and can be stowed when not used.

Alternatively, the additional space could be used for something else such as another radio or an external speaker or navigation system and still retain the convenience of a one-hand easy slide in and out automatically connecting and disconnecting all wires and power supplies via the novel instant invention bracket.

Specifically, the exemplary embodiment of the invention enables a single slide bracket to supply more than one coaxial cable and space for an additional electronic device with included additional accessory wires for additional applications thus enabling any modern multi-band capable radio to be controlled easily in one pull.

This instant slide mount is in a clam-shell shape where the lower portion of the clam shell would be attached to the radio bracket that comes with the radio using simple screws and bolts and the upper counterpart of the clamshell would be attached to the underside of the dashboard or other chosen area. Then they can be attached by sliding the lower radio portion into the top portion, creating a single clamshell secure electrical and coaxial connection of all of the included wiring for the specific application such as CB, Ham radio, police scanners, etc.

This has an additional feature such that it would deter any theft as the radio now becomes easily stowed out of site when not in use. But with this new configuration, the same radio can be used in multiple vehicles by just sliding the radio into the upper part of the mount. The upper portion can be used in multiple locations so that the electronic device can be swapped from vehicle to vehicle effortlessly.

Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1 is a schematic side view of the exemplary embodiment of the invention;

FIG. 2 is a schematic front view of the invention of FIG. 1;

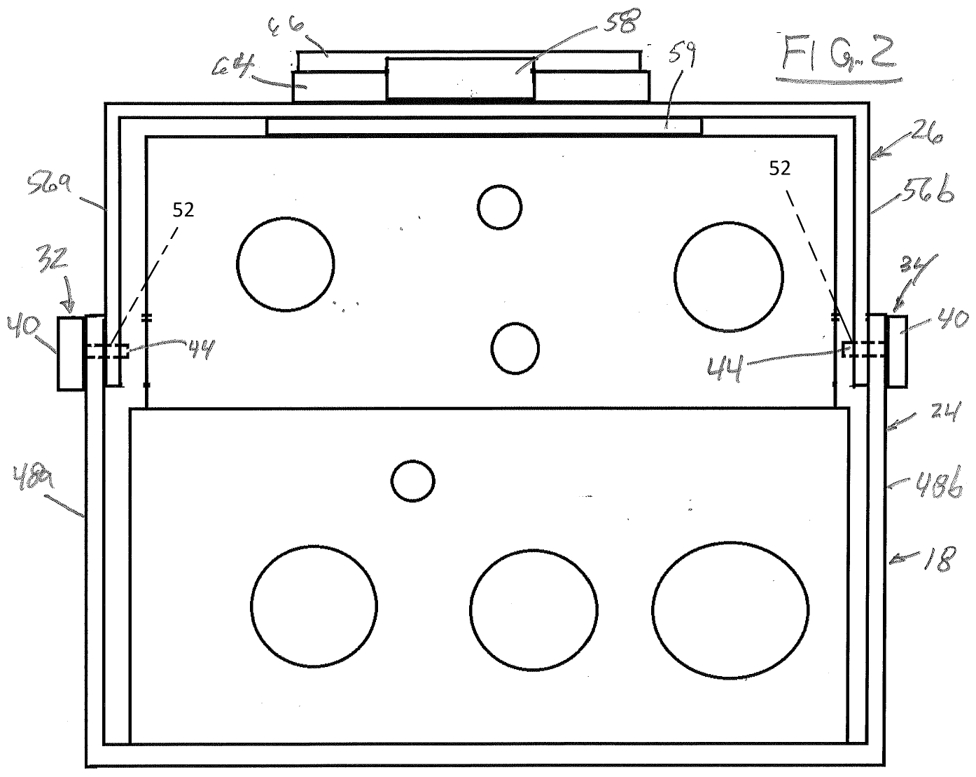

FIG. 3 is a schematic plan view of a first connector assembly from FIGS. 1 and 2;

FIG. 4 is a schematic plan view of a second connector assembly from FIGS. 1 and 2; and

FIG. 5 is a schematic enlarged side view taken from FIG. 1.

### DETAILED DESCRIPTION

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

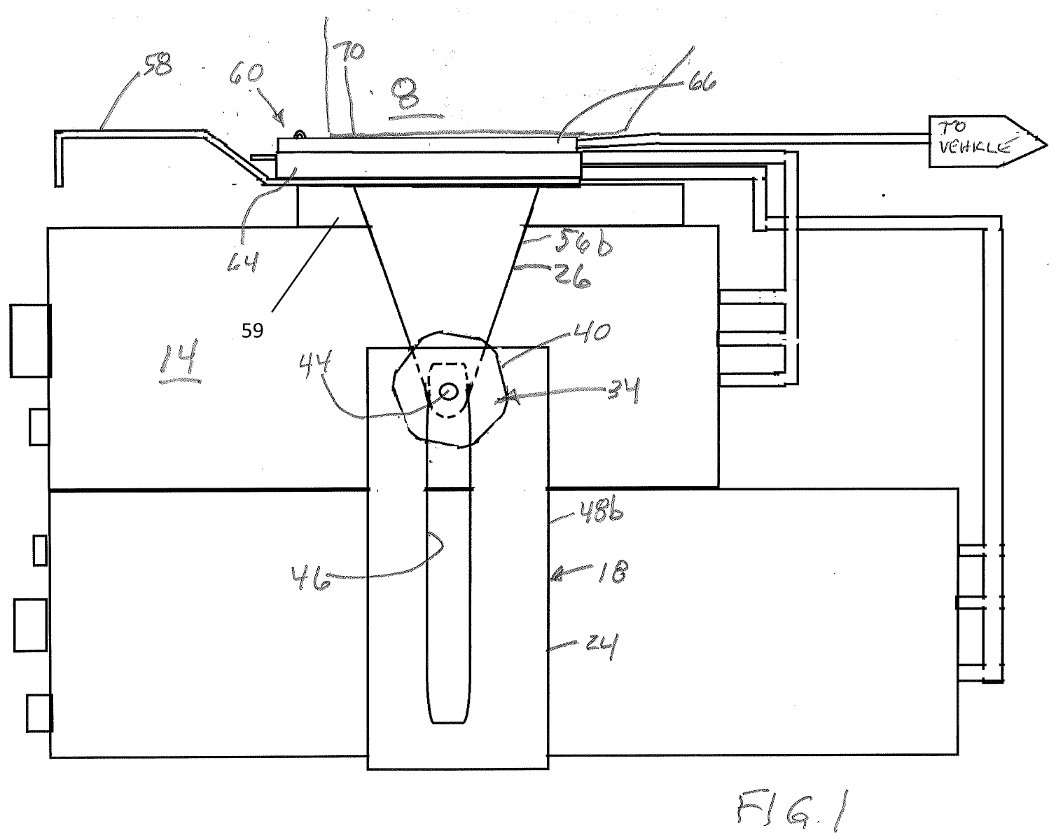

FIG. 1 illustrates an exemplary embodiment mounting arrangement for stacked components for vehicle mounting in a vehicle 8. The arrangement includes a lower first component 10 and an upper second component 14. The components can be police and fire scanners, Amateur Radio Band (Ham), Citizens Band (CB), Family Radio Service (FRS), General Mobile Radio Service (GMRS), simple stereo receivers, a speaker, amplifiers, or navigation systems.

The first and second components 10, 14 are held together by a bracket assembly 18. The bracket assembly 18 includes a U-shaped base bracket 24 and an overlying, inverted U-shaped upper bracket 26. The two brackets 24, 26 are fixed together by left and right fasteners 32, 34 which each include a turning knob 40 that extends into a threaded stud 44. The threaded stud extends through a slot 46 in left and right vertical legs 48a, 48b of the base bracket 24 and is threaded into a threaded hole 52 in each of left and right vertical legs 56a, 56b of the upper bracket 26. The slots 46 provide for vertical adjustment between the brackets 24, 26 to accommodate components 10, 14 of different height dimensions.

A handle 58 is attached or formed with the upper bracket 26.

A pad 59 can be arranged between the upper component and the upper bracket 26, which can be compressed to retain the stacked components snugly within the bracket assembly 18.

A plug and socket assembly 60 is provided above the upper bracket 26. The plug and socket assembly 60 includes a lower plug assembly 64 fixed to the upper bracket 26 and an upper socket assembly 66 fixed to a surface 70 of the vehicle 8. such as an under-dash surface.

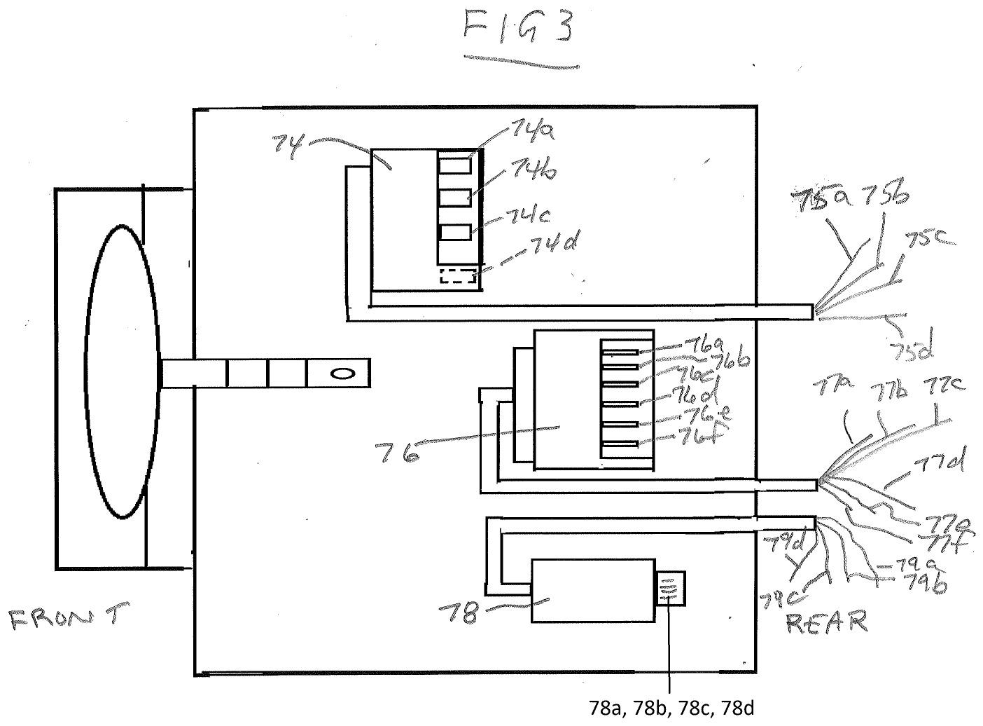

As shown in FIG. 3, the lower plug assembly 64 comprises a housing with an open top face and open front and rear ends. The lower plug assembly 64 includes a first plug 74, a second plug 76 and a third plug 78. The plugs 74, 76, 78 are multi-conductor plugs. The first plug 74 includes pins 74a, 74b, 74c, 74d, and corresponding wires 75a, 75b, 75c, 75d. The second plug 76 includes pins 76a, 76b, 76c, 76d, 76e, 76f. and corresponding wires 77a, 77b, 77c, 77d, 77e, 77f. The plug 78 is a Universal Serial Bus (“USB”) plug, such as standard USB, mini-USB or micro-USB plug, or USB-C plug and has four pins 78a, 78b, 78c, 78d, which connect to 79a, 79b, 79c, 79d.

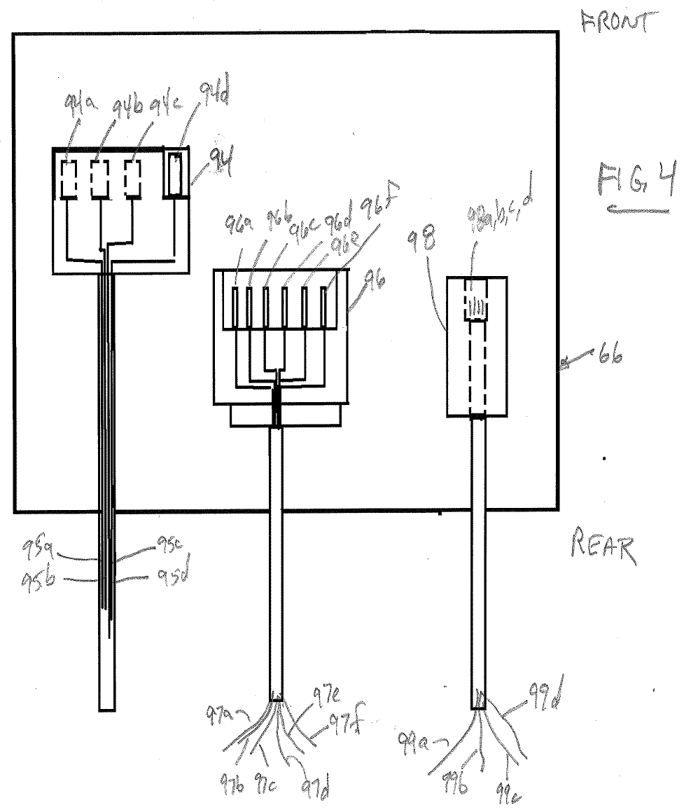

As shown in FIG. 4, the upper socket assembly 66 comprises a housing with an open bottom face and open rear and front ends. The upper socket assembly 66 includes a first socket 94, a second socket 96 and a third socket 98. The sockets 94, 96, 98 are multi-conductor sockets. The first socket includes pin connectors 94a, 94b, 94c, 94d. and corresponding wires 95a, 95b, 95c, 95d. The second socket 96 includes pin connectors 96a, 96b, 96c, 96d, 96e, 96f. and corresponding wires 97a, 97b, 97c, 97d, 97e, 97f. The socket 98 is a USB socket compatible with the USB plug 78 and has four pin connectors 98a, 98b, 99c, 98d connected to corresponding wires 99a, 99b, 99c, 99d.

The lower plug assembly 64 and the upper socket assembly 66 form a “clam shell’ arrangement with the upper socket assembly partially fitting vertically into the lower plug assembly, such that when slid together in a horizontal direction, the housings of the plug assembly and the lower socket assembly cover the top and bottom of the plugs and sockets.

The plugs and sockets of the upper socket assembly and the lower plug assembly are arranged within the upper socket assembly and the lower plug assembly, such that when the lower socket assembly is slid onto the upper plug assembly the plugs mate with respective sockets to make electrical connections. The plug 74 mates with the socket 94, the plug 76 mates with the socket 96, the plug 78 mates with the socket 98. The pins and pin connectors within each of the respective plugs and sockets make electrical connection per the Table A. below. The conductors are assigned the functions set forth in the Table A.

TABLE A

| Plug | Wires | Service | To/From |
|---|---|---|---|
| 74a | 75a | scanner signal (+) | to scanner component |
| 74b | 75b | scanner signal (−) | to scanner component |
| 74c | 75c | amplifier power (+) | to amplifier power input |
| 74d | 75d | amplifier power (−) | to amplifier power input |
| 76a | 77a | radio signal (+) | from amplifier input |
| 76b | 77b | radio signal (−) | from amplifier input |
| 76c | 77c | Radio power (+) | Radio power input |
| 76d | 77d | Radio power (−) | Radio power input |
| 76e | 77e | PA/External speaker (+) | Radio output |
| 76f | 77f | PA/External speaker | (−) Radio output |
| 78a | 79a | GPS signal (+) | to GPS device input |
| 78b | 79b | GPS signal (−) | to GPS device input |
| 78c | 79c | GPS power (+) | to GPS power input |
| 78d | 79d | GPS power (−) | to GPS power input |
| Socket | Wires | Service | To/From |
| 94a | 95a | scanner signal (+) | from scanner antenna |
| 94b | 95b | scanner signal (−) | from scanner antenna |
| 94c | 95c | amplifier power (+) | from vehicle power |
| 94d | 95d | amplifier power (−) | from vehicle power |
| 96a | 97a | radio signal (+) | from CB antenna |
| 96b | 97b | radio signal (−) | from CB antenna |
| 96c | 97c | Radio power (+) | from vehicle power |
| 96d | 97d | Radio power (−) | from vehicle power |
| 96e | 97e | PA/External speaker (+) | from Radio output |
| 96f | 97f | PA/External speaker (−) | from Radio oiutput |
| 98a | 99a | GPS signal (+) | from GPS antenna |
| 98b | 99b | GPS signal (−) | from GPS antenna |
| 98c | 99c | GPS power (+) | from vehicle power |
| 98d | 99d | GPS power (−) | from vehicle power |

The “Radio” in the above table can refer to CB Radio, or Amateur Radio or Family Radio Service, or General Mobile Radio Service. The “scanner” can be a police and fire scanner or other type scanner.

The conductors of the lower plug assembly 64 are connected to components 10 and 14 as set forth in Table A. The conductors have corresponding electrical connectors for connecting to inputs and outputs of components 10 and 14 or are hard wired thereto onto terminals without a connector.

The conductors of the upper socket assembly are connected to inputs and outputs of the vehicle as set forth in Table A. The conductors have corresponding electrical connectors, as applicable for connecting to inputs and outputs of the vehicle or are hard wired into the vehicle electric system, or are hard wired to vehicle-carried or mounted antennas.

In operation, the assembly of components 10, 14, the bracket assembly 18 and the lower plug assembly 64 as a unit are slid into a dedicated space in the vehicle 8, such as under the dash or console, using the handle 58. The upper socket assembly 66 is pre-attached to a position in the dedicated space of the vehicle 8 at the proper elevation.

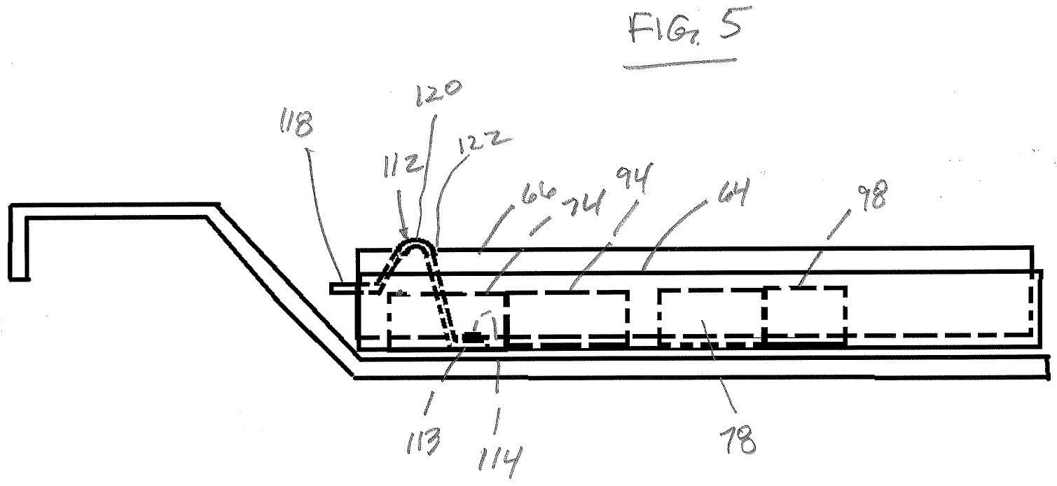

As shown in FIG. 5, the lower plug assembly 64 is slid under the upper socket assembly 66 and the plugs and sockets within the respective lower plug assembly 64 and the upper socket assembly 66 engage and mate together, such as the plug 74 mating with the socket 94, and the plug 78 mating with the socket 98, and the plug 76 mating with the socket 96 (not shown), to complete all the electrical connections.

Also shown in FIG. 5 is a leaf-spring latch 112 formed of a bent single piece of spring metal, and having a base 113 at one end that is riveted or otherwise attached to the floor of the lower plug assembly, such as by a rivet 114. At an opposite end of the latch, is a tab 118 and between the tab 118 and the base 113 is a fold or loop 120 which snaps into a slot 122 in the upper socket assembly 66. To slide the assembly of components 10, 14, bracket assembly 18 and lower plug assembly 64 into place, the lower plug assembly, attached to the upper bracket 26, is slid under the upper socket assembly 66 and the latch is depressed to allow the lower plug assembly 64 to fully engage with the upper socket assembly wherein the latch 112 is resiliently deflected downward and upon full engagement snaps upward into the slot 122.

Removal of the assembly of components 10, 14, the bracket assembly 18 and the lower plug assembly 64 as a unit is reversed, in that the tab 118 is depressed by the user's finger while the handle 58 is pulled to disengage the upper socket assembly from the lower plug assembly.

From the foregoing, it will be observed that numerous variations and modifications may be effectuated without departing from the spirit and scope of the invention. It is to be understood that no limitation with respect to the specific apparatus illustrated herein is intended or should be inferred.

The invention claimed is:

1. A combination bracket and electrical connector assembly for plural components for removable installation into a vehicle, comprising:
a bracket assembly that surrounds two stacked components, holding the two components together; and
an upper connector assembly having a first housing and a bottom open face and having plural first connecting elements mounted into the first housing, the upper connecting assembly arranged for mounting onto a vehicle surface;
a lower connector assembly having a second housing and a top open face and arranged for mounting onto the bracket assembly, the lower connector assembly having plural second connecting elements mounted into the second housing, the plural first connecting elements arranged to automatically engage the plural second connecting elements when the lower connector assembly is slid under the upper connector assembly.

2. The combination according to claim 1, wherein the first connecting elements comprise sockets and the second connecting elements comprise plugs.

3. The combination according to claim 1, wherein the first connecting elements comprise plugs and the second connecting elements comprise sockets.

4. The combination according to claim 1, wherein the first connecting elements comprise a mix of plugs and sockets and the second connecting elements comprise a mix of plugs and sockets.

5. The combination according to claim 1, wherein two of the plural first connecting elements and two of the plural second connecting elements are dedicated to connecting two antennas each dedicated to a different signal band.
